(19) United States
(12) Patent Application Publication
(10) Pub. No.: US 2008/0261420 A1
(43) Pub. Date: Oct. 23, 2008

(54) Safety electric plug for preventing electric shock

(76) Inventor: Charles Wayne Riddle, Nolensville, TN (US)

Correspondence Address: Charles Wayne Riddle, Jr.;7162 Nolensville Road, P.O. Box 42, Nolensville, TN, 37135, US

(21) Appl. No.: 12/082,010

(22) Filed: Apr. 8, 2008

Related U.S. Application Data
(60) Provisional application No. 60/922,597, filed on Apr. 9, 2007.

(51) Int. Cl. H01R 13/44

(52) U.S. Cl. 439/134

(57) ABSTRACT

Described is a safety power plug having electric plug prongs made of conductive material that exist having a insulated base portion housed inside the plug extending uniformly from and forming a nonconductive proximal portion, a conductive center portion and a distal nonconductive portion to allow the center conductive portion of the prong to be housed inside the female receptacle when a electrical connection is made thus preventing an electrical shock or fire.

### BACKGROUND

Electrical appliances, extension cords etc. have terminal plugs with two or more prongs that are inserted into a mating insulated receptacle where they engage electrically-conductive contacts which frictionally grip on the prongs to hold the plug in place.

Accidental or partial withdraw of the plug would leave a gap between the plug and receptacle exposing both prongs. If contact is lost the device will not operate. If electrical-contact still exists and a childs' finger, slender object such as a knife or a thin wire etc. made contact with one or both prongs, it could result in a potentially dangerous electrical shock or ignite a fire

Many safety devices have been created in an attempt to insulate the conductive prongs when the plug is not fully inserted either by insulating the plug prongs proximally or attaching a nonconductive material distally to the prongs or a sleeve, bellows or the like attached to the plug body surrounding the prongs.

Generally, electric plugs have conductive prongs made of metal partially embedded in a nonconductive plug housing or insulated directly on the prong which extends out of the plug body either non-insulated, partially insulated or fully insulated to the point that it will not interfere with the prong establishing contact with the female receptacle. Since the proximal insulation longitudinal length is limited to avoid interference with the prong establishing contact with the female receptacle when fully inserted, a portion of metal in many instances exposes an electrical shock or fire hazard when an initial connection is established.

In one version, the plug prongs are recessed proximally at the plug base and insulating material is inserted flush with the contour of the prong. As shown in U.S. Pat. No. 3,710,287-Eckert, U.S. Pat. No. 3,533,052-Degataeno, U.S. Pat. No. 5,641,311-Chuang, and U.S. Pat. No. 6,109,977-Baxter er al. The problem with this solution is the insulation material can only extend so far distally along the prong without interfering with the contact in the female receptacle when the plug is fully inserted. In many instances, if the plug is just partially inserted into a female receptacle and an electric connection is present, the proximal portion of the conductive segment of the prong is exposed and unhoused, presenting a shock and fire hazard.

Another type of plug feature is having the distal end of the prong insulated and the proximal part of the prong conductive as shown in U.S. Pat. No. 6,945,826-Wise which relies on making electrical contact when the plug is substantially fully inserted but thin objects such knives, wires and the like, could still be inserted between the plug face and receptacle and establish contact with the sides of the prongs creating a shock or a fire. A third proposed solution is shown in U.S. Pat. No. 3,631,320-Eckert featuring an addition of an insulation sleeve on the prongs adjacent to their bases. The problem with this solution is thickening the prong so much that insertion and withdraw are difficult and the sleeve is subject to be moved or damaged.

Another type of solution is a flexible, resilient, sleeve, or boot that attached to the plug body face surrounding the prong as shown in U.S. Pat. No. 3,631,320-Eckert, as the prongs are inserted in a female receptacle, the boot is compressed between the receptacle and prongs. This design is very susceptible to being damaged, cut or pulled off.

Thus, there is a need for a safety plug which will securely house the conductive portion of the plug prong and not be prone to exposure or damage.

### SUMMARY

It is therefore an object of the present invention to provide a safety electric plug which will prevent accidental electric shock or fire by providing better insulation effects by delaying electrical contact with an insulated distal end so the center conductive portion of the prong is securely housed inside the female receptacle.

Accordingly this invention features a safety electric plug having two or more electrically-conducting prongs extending from a plug body for insertion into an electric receptacle that has electrically-conductive contacts. Each prong is initially housed inside the plug structure with an initial conductive portion for attaching to electrical wires, followed by an insulated portion existing and extending outward having a continually insulated proximal base portion extending from the plug and including a exposed electrically-conductive center section and a distal portion having a non-conducting, insulated exterior for preventing said electrical connection upon initial insertion of the prong into a receptacle. The distal portion delays the electrical connection until the plug is inserted inward enough so as to establish contact with the conductive center section and with the same movement housing the conductive center portion more safely into the female receptacle housing at which point the plug is substantially if not fully inserted into the socket. The proximal insulated portion provides added shock and fire protection in the event a thin object such as a wire, knife or etc. should slide between the plug face and the front of the receptacle and touch the plug prongs. Some tolerances have to be made i.e. the positioning and length of the center conducting portion of the prong, for the manufacturing differences in the length between the receptacle face front and female contacts inside the receptacle to insure the invention performs substantially with all available receptacles.

### DESCRIPTION OF DRAWINGS

FIG. 1 is a diagram showing partially in cross-section a power source plug;

FIG. 2 is a perspective view of a recessed power plug prong;

FIG. 3 is a perspective view of a power plug prong with insulation material applied;

FIG. 4 is a perspective view of a safety power plug;

FIG. 5 is a front view of a conventional double socket electric type wall-type receptacle, illustrated alone for clarity;

FIG. 6 is a sectional view taken along line 6-6 of FIG. 1, additionally showing an American 110 v electric plug poised for insertion in the upper socket;

FIG. 7 is a similar view to FIG. 2, but showing the plug prong partially inserted;

FIG. 8 is a similar view of FIG. 3, but showing the plug prong fully inserted;

FIGS. 9, 10, 11 and 12 are perspective views of non-American-style plugs which incorporate the invention.

### DETAILED DESCRIPTION OF THE INVENTION

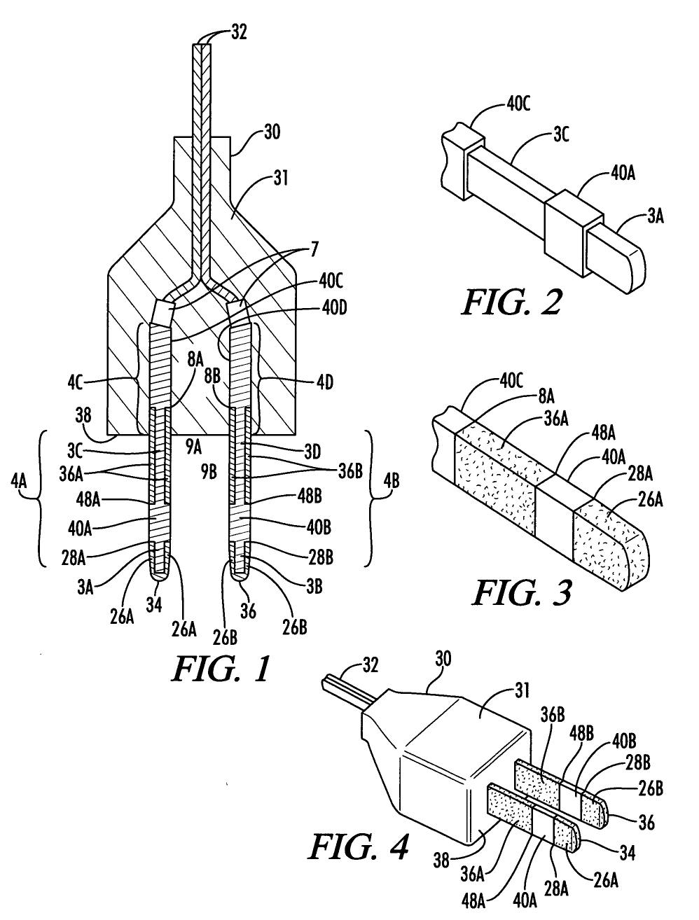

A safety electric plug of the present invention will be described with the reference FIGS. 1-8.

The safety electric plug 30, as shown in cross section FIG. 1, comprises a pair of prongs 34 and 36 which are tightly supported inside the plug body 31 and prong portions 4C and 4D.

Inside said plug body 31 caulked portions 7 are connecting power cord source 32 and terminal members 4C and 4D and consequently to plug portions 4A and 4b respectively, extending out of the plug body to be inserted into power source receptacle 10.

A pair of prongs 34 and 36 are each made of a conductive metal plate which is recessed as in portions 3A and 3C in FIG. 2 to receive material such as plastic etc. to insulate the conductive metal and to form a flush contour at the joints 8A, 48A and 28A. Portions 26A and 26B slope slightly inward as they protrude to their outer most point so as to easily enter a female receptacle 24, FIG. 8 and not interfere with the center contact portion 40A and 40B when the prong are fully plugged into the female receptacle 24. As shown in FIG. 1 portions 9A and 9B exists inside and extend outside the plug housing to insulate that portion of the prong. An adhesive etc. may be used where prongs 34 and 36 exits and extend out of the plug face 38 to reinforce the insulation in that area.

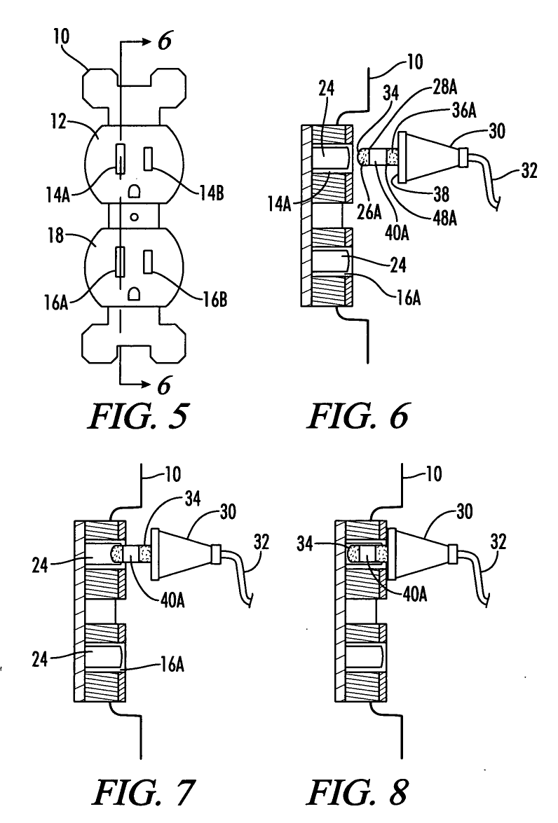

Referring now to FIGS. 5-8, a conventional wall-type 110 v double electrical receptacle 10 is normally mounted in an electrical box in a wall and covered with a wall plate, not illustrated, in a conventional manner to provide 110 v electric service for lamps and small appliances in homes, offices and other buildings. Receptacle 10 includes an upper socket 12 having slots 14A and 14B for receiving plug prongs and lower socket 18 having slots 16A and 16B for receiving prongs of and electrical plug. Each socket slot has a pair of internal spaced, parallel electricity-conducting contacts or blades, which is 24 shown in FIGS. 5-8. The blade 24 serves two functions, to grip and frictionally retain electrical plug prongs and to make electrical contact with the prongs.

FIG. 4 shows an electrical plug 30 according to this invention. Plug 30 is at the terminal end of an electrical cord 32 that is attached to an electrical device or appliance (not shown) such as a radio, TV, fan, power tools, etc. and can be to different aspects such as on an extension cord, a replacement plug, an ejection molded plug etc. Plug 30 has a non-conductive body 31 made from a dielectric material, such as plastic, and has a front face 38 from which extends large and small prongs 34 and 36. In normal electric plugs, the prongs are made of conducting metal so that upon insertion into a socket, they make electrical contact with the blades 24 to conduct electric current to operate the device or appliance connected to the plug.

In a conventional plug, electrical contact is made upon only partial plug insertion. If the plug prongs are not fully inserted into the receptacle, and are partially exposed, contact with the prongs by someone such as a child, can cause electric shock or fire. This partial insertion can be caused by plug insertion with insufficient force or by partial plug withdrawal, such as when the cord is stressed sufficiently to partially withdraw the plug from the socket. This will still operate, since action may well go unnoticed because the connected appliance current is still flowing to it. As such a partially inserted conventional plug is an accidental shock safety hazard.

The plug 30 of this invention substantially removes this accidental shock hazard. As best seen in FIG. 1, a diagram showing a cross section of a electric safety plug 30, prongs 34 and 36 exist in and extends from the plug face 38 and has formed a base and proximal portion or segment 9A and 9B that is covered by a non-conductive material such as plastic or another insulating material but does not interfere with the electrical contact between the plug prong 34 and the female receptacle conductive blade 24 before and when the prong is fully inserted. In FIGS. 2 and 3, the conductive metal of the prong has been recessed where the non-conductive material exists so the prong is essentially flush at all joints. The inward slope from joint 28A to form a thinner and chamfered end so as to more easily enter the female receptacle but not to extend proximally so as to interfere with the electrical contact made with the conductive center section 40A and the female contact receptacle blade 24.

The electrical conductive center prong portions 40A and 40B are connected to the electric wires in cord 32 that conveys electric current to the connected appliances. With this arrangement when plug 30 is only partially inserted into the female receptacle, as in FIG. 7, only the distal nonconductive prong portion 26A will contact socket blade 24 and there is no chance of an accidental electric shock although the plug will remain only partially inserted. The longitudinal length of the nonconductive distal portion 26A delays the initial electrical contact by the female receptacle prong 24 and plug prong 34 conductive center portion 40A and thus allows the conductive center portion to be further housed inside the female inlet receptacle 14A before an electrical connection is established and therefore eliminates an accidental electrical shock. As the plug is fully inserted, the center conductive portion 40A of the prong moves further into the receptacle female contact 24 resulting in electrical conductance. The nonconductive proximal portion 36A of the prong advances further into the receptacle housing without interfering with the electrical contact which enables the appliance to function and provides insulating shock protection.

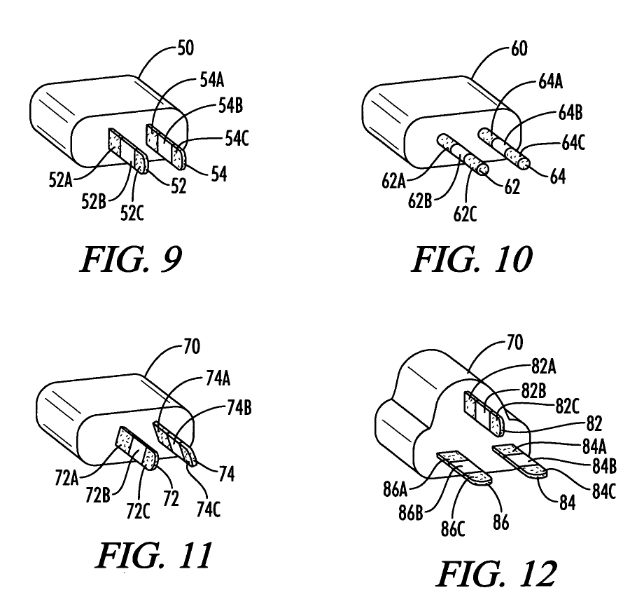

Although FIGS. 1-8 illustrate use of the invention in an American-style 110v plug, it is useful in other types of plugs conventionally used for 220v and other voltages in this country. It can also be used in electrical plugs used in other parts of the world, as illustrated in FIGS. 9, 10, 11 and 12. Plug 50 has prongs 52, 54 each having nonconductive proximal segments 52A, 54A and non-conductive distal portions 52C and 54C and conductive center portions 52B and 54B. Similarly, plug 60 has prongs 62, 64 with nonconductive proximal segments 62A and 64A and nonconductive distal portions 62C, 64C and conductive center 62B and 64B while plug 70 has prongs 72, 74 with nonconductive proximal segments 72A, 74A and nonconductive distal portions 72C, 74C and conductive center portions 72B and 74B. Plug 80 has three prongs 82, 84, and 86 having conductive center segments 82B, 84B and 86B and non-conductive distal portions 82C, 84C and 86C and nonconductive proximal segments 82A, 84A and 86A.

The actual prong structure may take many forms, the conducting center section could also have non-conducting material along its top and bottom edges and/or said material partially recessed along its sides. Alternatively, the exposed conducting portion of the center section could be only on the facing, or only on the non-facing surfaces of the prongs. The conducting metal portion of the prong in areas where metal has been recessed and insulation material has been added, holes, slits or serrations and undercutting metal etc. may be performed on the metal to assist in the bonding aspects. The actual plug structure may take many forms as well such as injection molding, screw and puncture type wire attachment etc.

While the safety electric plug is described in the above embodiments, it can be said that the present invention can be applied to any electric equipment using a power source plug of the present invention and to a power plug equipped with a connection terminal member such as an AC/DC conversion adaptor, table tap or the like. While the power source plug has two connection terminal members in the above embodiments, the power source plug many have one or three or more connection terminal members.

Having described the preferred embodiments of the present invention with reference to the accompanying drawings, it is to be understood that the present invention is not limited to the above-mentioned embodiments and that various changes and modifications can be effected therein by one skilled in the art without departing from the spirit or scope of the present invention as defined in the appended claims.

I claim:

1. An electric safety plug for connecting an electrical device to a source of electric current in a conventional electric receptacle which has electric contacts for gripping the exterior of and establishing an electrical connection with each plug prong, comprising
a plug body,
a pair of spaced prongs extending from the plug body for insertion into a socket,
the prongs each having a recess formed in the proximal part of the prong and extending out of the plug body with an insulation material surrounding and secured to the proximal recessed portion of the prong,
the center portion remaining conductive with a distal portion of the prong recessed with an insulated material surrounding and secured to the distal recessed portion of the prong,
the center portion having an electrically conductive exterior segment for establishing a electrical connection with a female receptacle upon substantially full insertion of the prong into the receptacle,
the distal portion having a nonconductive exterior for preventing and delaying said electrical connection upon partial insertion of the plug into the receptacle and to allow the conductive center section of the prong to advance into and be safely housed in the female receptacle body thereby preventing said electrical connection until the plug is substantially fully inserted into the socket to prevent accidental electric shock or fire.

2. A safety electric plug having two or more electrically-conductive prongs extending from a plug body for insertion into a conventional electric receptacle that has electrically-conductive contacts, each prong having
a base portion extending from the plug comprising a first nonconductive exterior segment,
an exposed electrically-conductive center segment extending from the base portion,
and a end portion extending from the center segment comprising a second nonconductive exterior segment, whereby the center segment is sized to establish electrical connection with a contact only upon substantially full insertion of the plug into the receptacle.

3. A method of preventing an electrical shock by contact with portions of the prongs of an electric plug upon partial insertion of the plug into a conventional electric receptacle, comprising the steps of
providing each prong with a base portion extending from the plug that has a nonconductive exterior segment,
providing each prong with a center portion extending from the base portion that has a conductive exterior segment,
providing each prong with a end portion with a nonconductive exterior segment extending from the center portion and,
sizing both prongs such that substantial full insertion of the prongs into the receptacle is necessary to establish electrical connection between the plug and the receptacle.
